(19) United States
(12) Patent Application Publication
(10) Pub. No.: US 2026/0189821 A1
(43) Pub. Date: Jul. 2, 2026

(54) IMAGE SENSOR DEVICES AND COMPARISON DEVICES

(71) Applicant: Samsung Electronics Co., Ltd., Suwon-si (KR)

(72) Inventors: Sun Yool KANG, Suwon-si (KR); Hae Sick SUL, Suwon-si (KR); Hee Sung CHAE, Suwon-si (KR)

(73) Assignee: Samsung Electronics Co., Ltd., Suwon-si (KR)

(21) Appl. No.: 19/240,506

(22) Filed: Jun. 17, 2025

(30) Foreign Application Priority Data
Dec. 30, 2024 (KR) 10-2024-0201046

(51) Int. Cl. H04N 25/78; H04N 25/616; H04N 25/771

(52) U.S. Cl. CPC H04N 25/78; H04N 25/616; H04N 25/771

(57) ABSTRACT

An image sensor and a comparison device included in the image sensor are provided. The image sensor includes a plurality of ramp voltage buffers configured to buffer a ramp signal, a pixel array including a plurality of pixels, and a plurality of column lines respectively connected to the plurality of pixels, and a plurality of comparators, each of the plurality of comparators being configured to receive the buffered ramp signal from one of the ramp voltage buffers, receive a pixel signal via one of the plurality of column lines, compare the buffered ramp signal with the pixel signal, and output a comparison signal via output nodes, a voltage level swing width of the output nodes being restricted based on control of a voltage level of a common gate node between output transistors.

### CROSS-REFERENCE TO RELATED APPLICATION

This application claims priority from Korean Patent Application No. 10-2024-0201046 filed on Dec. 30, 2024 in the Korean Intellectual Property Office, and all the benefits accruing therefrom under 35 U.S.C. 119, the contents of which are herein incorporated by reference in their entirety.

### TECHNICAL FIELD

The present disclosure relates to an image sensor device, and more particularly, to an analog-to-digital converter circuit used in an image sensor device.

### DESCRIPTION OF THE RELATED ART

Types of image sensors include a charge coupled device (CCD) image sensor, a complementary metal-oxide semiconductor (CMOS) image sensor (CIS), and the like. The CMOS image sensor includes pixels composed of CMOS transistors and converts light energy into electrical signals by using a photoelectric conversion element included in each pixel. The CMOS image sensor acquires information on a photographed image by using the electrical signal generated from each pixel.

An analog-to-digital converter (ADC) receives an analog input voltage generated from a pixel and converts the received analog input voltage into a digital signal. The converted digital signal may be transmitted to other devices. The ADC may be used in various signal processing devices. Recently, as performance of the signal processing devices is improved, improved resolution of an analog signal is required (or at least desirable).

However, the image sensor may become vulnerable to signal banding noise while increasing a readout speed for an image pixel or increasing a bias current to improve resolution in a state that a thickness of an oxide film becomes thin due to scale-down of the image sensor.

### BRIEF SUMMARY

Some example embodiments provide an image sensor for reducing kickback noise generated when a comparator operates in an analog converter circuit of the image sensor.

One aspect of the present disclosure provides an image sensor including a plurality of ramp voltage buffers configured to buffer a ramp signal, a pixel array including a plurality of pixels, and a plurality of column lines respectively connected to the plurality of pixels, and a plurality of comparators, each of the plurality of comparators being configured to receive the buffered ramp signal from one of the ramp voltage buffers, receive a pixel signal via one of the plurality of column lines, compare the buffered ramp signal with the pixel signal, and output a comparison signal via output nodes, a voltage level swing width of the output nodes being restricted based on control of a voltage level of a common gate node between output transistors.

One aspect of the present disclosure provides a comparison device including a current mirror circuit configured to receive a ramp signal and a pixel signal, and compare the ramp signal with the pixel signal to output a first comparison signal and a second comparison signal, the first comparison signal being output through a first output node of a first output transistor, and the second comparison signal being output through a second output node of a second output transistor, and a first internal clamping control transistor connected in a diode-connected structure between a common gate node and the first output node, the common gate node being between the first output transistor and the second output transistor, and the first internal clamping control transistor being configured to restrict a voltage swing width of the second comparison signal.

One aspect of the present disclosure provides an image sensor including a ramp signal generator configured to generate a ramp signal, a plurality of ramp voltage buffers configured to buffer the ramp signal, a pixel array configured to output a pixel signal through a plurality of column lines, the pixel signal corresponding to incident light, a plurality of comparators, each of the plurality of comparators including a first output transistor having a gate connected to one of the plurality of column lines, and a drain connected to a first output node, a second output transistor having a gate connected to one of the plurality of ramp voltage buffers, and a drain connected to a second output node, and a first internal clamping control transistor connected in a diode-connected structure between the first output node and a common gate node of the first output transistor and the second output transistor, the first internal clamping control transistor being configured to control a voltage level of the second output node by controlling a gate voltage of the first output transistor and the second output transistor, and each of the plurality of comparators being configured to output a comparison signal to the first output node and the second output node, the comparison signal corresponding to a comparison between the pixel signal and the buffered ramp signal, a plurality of counters configured to count the comparison signal output from each of the plurality of comparators according to an operating clock to obtain counting information, and a plurality of memories configured to store the counting information from the plurality of counters, image data being output based on the counting information stored in the memory.

One aspect of the present disclosure provides a method including receiving a pixel signal and a ramp signal, the pixel signal corresponding to incident light, comparing the pixel signal and the ramp signal to generate a comparison signal, outputting the comparison signal via output nodes, and controlling a voltage level swing width of the output nodes including controlling a voltage level of a common gate node between output transistors.

The objects of the present disclosure are not limited to those mentioned above and additional objects of the present disclosure, which are not mentioned herein, will be clearly understood by those skilled in the art from the following description of the present disclosure.

### BRIEF DESCRIPTION OF THE DRAWINGS

FIG. 1 illustrates an example of a configuration of an image processing block 10 according to some example embodiments of the present disclosure.

FIG. 2 illustrates an example of the configuration of the image sensor 14 of FIG. 1.

FIG. 3 is an operation timing diagram illustrating a ramp signal RAMP, a pixel signal Vpx and a counter signal of FIG. 2.

FIG. 4 is a circuit diagram illustrating some example embodiments of the comparator 151 in the ADC block 150 of FIG. 2.

FIG. 5 is an operation timing diagram of a comparator circuit of FIG. 4.

FIG. 6 is an enlarged view of an output signal OUTN of FIG. 4.

FIG. 7 is a circuit diagram illustrating some example embodiments of the comparator 151 in the ADC block 150 of FIG. 2.

FIG. 8 is a circuit diagram illustrating some example embodiments of the comparator 151 in the ADC block 150 of FIG. 2.

FIG. 9 is a circuit diagram illustrating some example embodiments of the comparator 151 in the ADC block 150 of FIG. 2.

FIG. 10 is a circuit diagram illustrating some example embodiments of the comparator 151 in the ADC block 150 of FIG. 2.

FIG. 11 is a circuit diagram illustrating some example embodiments of the comparator 151 in the ADC block 150 of FIG. 2.

FIG. 12 is a flowchart illustrating a method for controlling a voltage level swing width according to some example embodiments.

### DETAILED DESCRIPTION OF THE DISCLOSURE

FIG. 1 illustrates an example of a configuration of an image processing block 10 according to some example embodiments of the present disclosure. The image processing block 10 may be implemented as a portion of various electronic devices such as a smartphone, a digital camera, a laptop and a desktop. The image processing block 10 may include a lens 12, an image sensor 14, an image signal processor (ISP) front end block 16, and/or an image signal processor 18. According to some example embodiments, operations described herein as being performed by image processing block 10, the image sensor 14, the ISP front end block 16, and/or an image signal processor 18 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Light may be reflected by an object, a landscape, etc., to be photographed, and the lens 12 may receive the reflected light. The image sensor 14 may generate an electrical signal based on the light received through the lens 12. For example, the image sensor 14 may be implemented as a complementary metal oxide semiconductor (CMOS) image sensor or the like. For example, the image sensor 14 may be a multi-pixel image sensor having a dual pixel structure or a tetracell structure.

The image sensor 14 may include a pixel array. Pixels of the pixel array may generate pixel values by converting light into electrical signals.

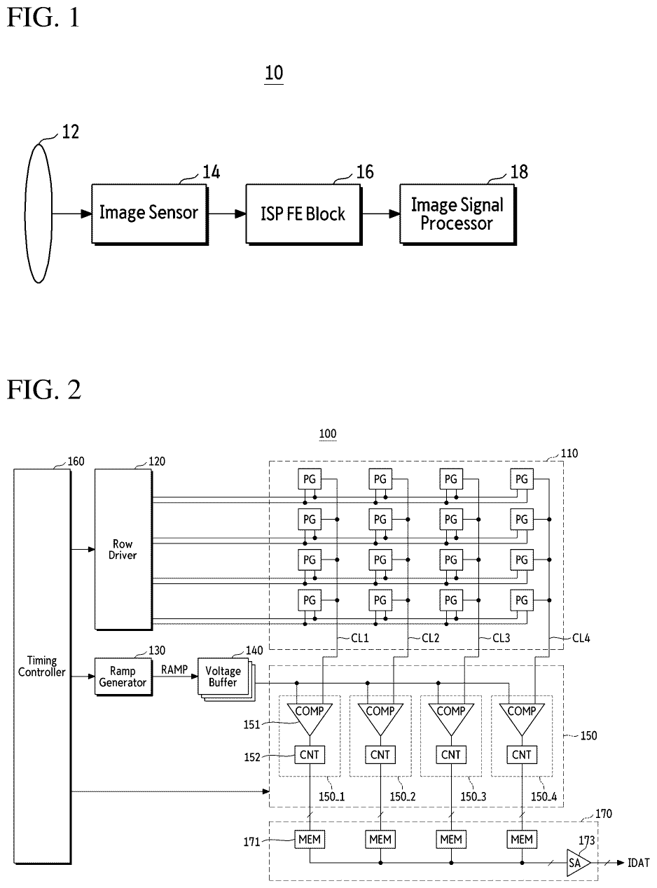

Furthermore, the image sensor 14 may include an analog-to-digital converter (ADC) circuit for performing correlation double sampling (CDS) for pixel values. The configuration of the image sensor 14 will be described in more detail with reference to FIG. 2.

The ISP front end (FE) block 16 may preprocess (or process) the electrical signal output from the image sensor 14 and process the electrical signal into a form appropriate to be processed by the image signal processor 18. Also, the ISP front end block 16 of the present disclosure may selectively preprocess (or process) an electrical signal corresponding to a lower conversion gain condition and/or preprocess (or process) an electrical signal corresponding to a higher conversion gain condition, based on the output of the image sensor 14.

The image signal processor 18 may generate image data related to a photographed object, a landscape, and the like, by appropriately processing the electrical signal processed by the ISP front end block 16. To this end, the image signal processor 18 may perform various processes such as color correction, auto white balance, gamma correction, color saturation correction, bad pixel correction, hue correction, etc.

FIG. 1 represents one lens 12 and one image sensor 14. However, in some example embodiments, the image processing block 10 may include a plurality of lenses, a plurality of image sensors, and/or a plurality of ISP front end blocks. In this case, the plurality of lenses may have different angles of view. In addition, the plurality of image sensors may have different functions, different performances, and/or different characteristics, and may include pixel arrays of different configurations.

FIG. 2 illustrates an example of the configuration of the image sensor 14 of FIG. 1.

Referring to FIG. 2, the image sensor 100 may include a pixel array 110, a row driver 120, a ramp signal generator 130, a voltage buffer 140, an ADC block 150, a timing controller 160, and/or a buffer 170. According to some example embodiments, the image sensor 14 may be implemented by the image sensor 100. According to some example embodiments, operations described herein as being performed by the image sensor 100, the pixel array 110, the row driver 120, the ramp signal generator 130, the voltage buffer 140, the ADC block 150, and/or the timing controller 160 may be performed by processing circuitry. According to some example embodiments, the buffer 170 may be implemented by a tangible, non-transitory computer-readable medium.

The pixel array 110 may include a plurality of pixels arranged in a matrix form along rows and columns. Each of the pixels may include a photoelectric conversion element. For example, the photoelectric conversion element may include a photodiode, a phototransistor, a photo gate, a pinned photodiode, etc. According to some example embodiments, the photoelectric conversion element may convert light reflected from an object, and incident on the photoelectric conversion element, into an electrical signal representing the light.

The pixel array 110 may include a plurality of pixel groups PG. Each pixel group PG may include two or more pixels. A plurality of pixels constituting the pixel group may share one floating diffusion region or a plurality of floating diffusion regions. Although the pixel array 110 of FIG. 2 is shown as including the pixel groups PG of four rows and four columns (e.g., 4×4), the present disclosure is not limited thereto.

The pixel group PG may include pixels of the same color (or similar colors). For example, the pixel group PG may include a red pixel for converting light in a red spectrum region into an electrical signal, a green pixel for converting light in a green spectrum region into an electrical signal, or a blue pixel for converting light in a blue spectrum region into an electrical signal. For example, the pixels constituting the pixel array 110 may be arranged in the form of a Tetra-Bayer pattern.

Each of the plurality of pixels of the pixel array 110 may output a pixel signal along column lines CL1 to CL4 in accordance with the intensity of light or the amount of light, which is received from the outside (e.g., from outside of the image processing block 10). For example, the pixel signal may be an analog signal corresponding to the intensity of light or the amount of light, which is received from the outside. The pixel signal may be provided to the ADC block 150 through the column lines CL1 to CL4 by passing through a voltage buffer (e.g., a source follower).

The row driver 120 may select and drive rows of the pixel array 110. The row driver 120 may decode an address and/or a control signal, which is generated by the timing controller 160, to generate control signals for selecting and driving the rows of the pixel array 110. For example, the control signals may include a signal for selecting a pixel or a signal for resetting the floating diffusion region.

The ramp signal generator 130 may generate a ramp signal RAMP under the control of the timing controller 160. For example, the ramp signal generator 130 may operate under a control signal such as a ramp enable signal. When the ramp enable signal is activated, the ramp signal generator 130 may generate the ramp signal RAMP in accordance with a preset (or alternatively, given) value (e.g., a start level, an end level, a slope, etc.). In other words, the ramp signal RAMP may be a signal that is increased or decreased in accordance with a preset (or alternatively, given) slope for a specific time period. The ramp signal RAMP may be provided to the ADC block 150 by passing through the voltage buffer 140.

The ADC block 150 may receive pixel signals from the plurality of pixels of the pixel array 110 through the column lines CL1 to CL4, and may receive the ramp signal RAMP from the ramp signal generator 130 through the voltage buffer 140. The ADC block 150 may be operated based on a correlated double sampling (CDS) technique that acquires a reset signal and an image signal with respect to the received pixel signals, and extracts their difference as a valid signal component. The ADC block 150 may include a plurality of ADC blocks (e.g., 150_1 to 150_4), and each ADC block may include a comparator COMP 151 for receiving the pixel signal and the ramp signal and comparing the pixel signal with the ramp signal, and a counter CNT 152 for counting a comparator output signal in accordance with a clock signal.

Each of the ADC blocks 150-1 to 150-4 connects each of the plurality of column lines CL1 to CL4 to a first input, and connects each of a plurality of voltage buffers 140 transferring the ramp signal RAMP generated by the ramp signal generator 130 to a second input. For example, the first ADC block 150-1 uses a first column line CL1 and a first ramp voltage buffer 140-1 as inputs, the second ADC block 150-2 uses a second column line CL2 and a second ramp voltage buffer 140-2 as inputs, and the third ADC block 150-3 uses a third column line CL3 and a third ramp voltage buffer 140-3 as inputs, and the fourth ADC block 150-4 uses a fourth column line CL4 and a fourth ramp voltage buffer 140-4 as inputs.

The comparators 151 may perform correlated double sampling (CDS) by comparing an analog output signal for each column of the pixel array with the ramp signal RAMP. The counters 152 may count pulses of the comparator output signal, for which the correlated double sampling has been performed, and may output the counted pulses as digital signals. For example, the counter 152 may operate under a control signal such as a counter enable signal CNT_EN, a counter clock signal and/or an inversion signal that inverts an internal bit of the counter 152.

The timing controller 160 may generate a control signal and/or a clock for controlling the operation and/or timing of each of the row driver 120, the ramp signal generator 130 and/or the ADC block 150.

The buffer 170 may include memories (MEM) 171 and sense amplifiers (SA) 173. The memories 171 are provided as a plurality of memories and each respective memory is connected to a corresponding the ADC block 150 which is connected to a plurality of pixel lines. The memories 171 may store digital signals output from corresponding counters 152 of the ADC block 150. According to some example embodiments, the stored digital signals may be displayed on a screen (e.g., a display, a monitor, a touchscreen, etc.) as an image of the object corresponding to the electrical signal generated by the pixel array 110.

At least one sense amplifier SA connected to the plurality of memories 171 may sense and amplify the stored digital signals. The sense amplifier SA may output the amplified digital signals as image data IDAT, and the image data IDAT may be transmitted to the ISP front end block 16 of FIG. 1.

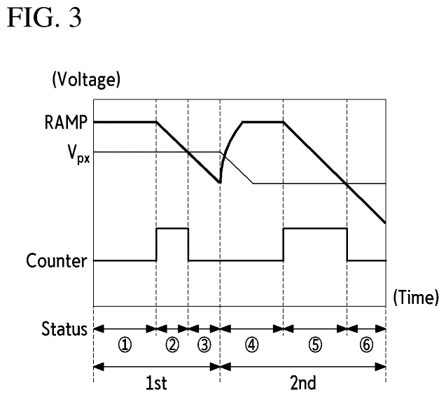

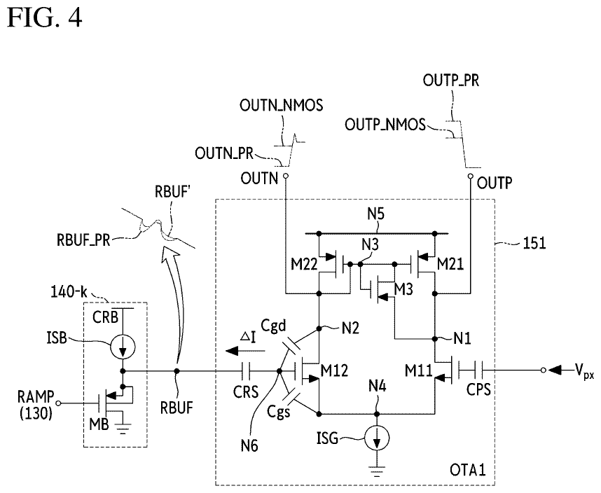

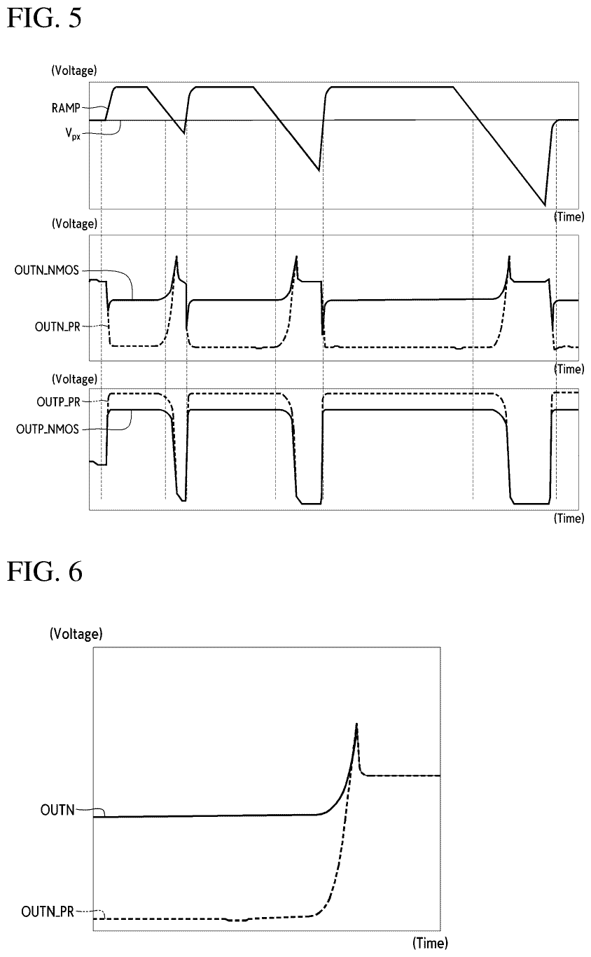

FIG. 3 is an operation timing diagram illustrating a ramp signal RAMP, a pixel signal Vpx and a counter signal of FIG. 2, and FIG. 4 is a circuit diagram illustrating some example embodiments of the comparator 151 in the ADC block 150 of FIG. 2. FIG. 5 is an operation timing diagram of a comparator circuit of FIG. 4, and FIG. 6 is an enlarged view of an output signal OUTN of FIG. 4.

A comparator 151 and a ramp voltage buffer 140-k, which are connected to one column line, are shown for definite description and conciseness of the drawings, and their connection configuration and function with the pixel array 110 are as described with reference to FIG. 2.

The comparator 151 receives the pixel signal Vpx output from the column line of the pixel array 110 in one terminal, receives the ramp signal RAMP applied from the ramp signal generator 130 in the other terminal, compares values of the two signals in accordance with the control signal from the timing controller 160, and outputs a comparison signal.

The comparator 151 performs correlated double sampling by comparing the reset signal or the image signal of the pixel signal Vpx with the ramp signal RAMP. For example, referring to FIG. 3, the comparator 151 operates at a reset period (1st period) and a pixel sensing period (2nd period).

At the reset period (1st period), when the ramp signal RAMP is reset enabled, its voltage level is decreased (\textcircled{2}\textcircled{3}) or increased (\textcircled{4}) to a constant magnitude as time elapses after an initialization period starts (\textcircled{1}). The pixel signal Vpx has a reset voltage level that is constantly maintained by the reset signal at the initialization period (\textcircled{1}). At a period at which the ramp signal RAMP is maintained at a constant reset voltage level, when the ramp signal RAMP is decreased (\textcircled{2}), a time point at which values of two signals input to each comparator are matched with each other occurs. As the time point at which voltage levels of the two signals become the same as (or similar) each other (or cross) passes, an inversion occurs in the value of the comparison signal output from each comparator 151 (\textcircled{3}).

The counter 152 outputs counting information by counting clocks from a time point when the ramp signal RAMP descends to the moment when the comparison signal output from the comparator 151 is inverted (\textcircled{2}). In this case, each counter is initialized in accordance with a reset control signal from the controller of the image sensor. The memory 171 stores primary (or first) counting information of the period \textcircled{2} from the counter 152.

At the pixel sensing period (2nd period), the voltage level of the pixel signal Vpx is gradually decreased in accordance with the amount of light incident on the sensor. When the ramp signal RAMP is increased (\textcircled{4}) and then decreased to a certain magnitude (\textcircled{5} \textcircled{6}), secondary (or second) counting starts from the time point when the ramp signal is decreased to the time point when the values of the two signals input to the comparator 151 are matched with each other (\textcircled{5}). The secondary counting ends (\textcircled{6}) when the value of the comparison signal output from the comparator 151 is inverted again after the time point when the values of the two signals are matched with (or cross) each other.

The image sensor calculates a difference between the secondary counting information and the primary counting information stored in the buffer 170, and outputs the difference value as the image data IDAT through the sense amplifier 173.

For example, the comparator 151 of FIG. 2 may be implemented as a single slope analog-to-digital conversion device. The single slope analog-to-digital conversion device may be implemented, for example, as an operational transconductance amplifier (OTA) that uses five or more transistors, but some example embodiments are not limited thereto. For example, the comparator 151 may include a larger number of OTAs.

In the shown example, the single slope analog-to-digital conversion device is implemented as a single-stage OTA. The comparator 151 may include a plurality of transistors M11, M12, M21, M22 and M3, a plurality of switches, and a first current source ISG. For example, the first input transistor M11 and the second input transistor M12 may be NMOS transistors, the first output transistor M21, the second output transistor M22 and the internal clamping control transistor M3 may be PMOS transistors. The fourth output transistor M22 may be implemented as a PMOS transistor having a diode-connected structure in which a gate and a drain are connected to a common node N3.

The internal clamping control transistor M3 may be implemented as a PMOS transistor having a diode-connected structure. In detail, a drain of the internal clamping control transistor M3 is connected to a gate of the third output transistor M21, e.g., the common node N3 of a current mirror, a source of the internal clamping control transistor M3 is connected to a drain of the third output transistor M21, e.g., an output node N1, and a gate and a drain of the internal clamping control transistor M3 are connected to the common node N3 of the current mirror. According to some example embodiments, sources of the third output transistor M21 and the fourth output transistor M22 may be connected to a first power voltage line N5.

A pixel sampling capacitor CPS for receiving the pixel signal Vpx may be included in front of a gate terminal of the first input transistor M11, and a ramp sampling capacitor CRS for receiving a ramp signal may be included in front of a gate terminal of the second input transistor M12 (at a common node N6). For example, the ramp signal provided to the ramp sampling capacitor CRS may be a buffed ramp signal RBUF. The pixel sampling capacitor CPS and the ramp sampling capacitor CRS may be parasitic capacitors generated at the gate terminal of each of the input transistors M11 and M12 by switching during the operation of the comparator 151.

The ramp signal RAMP may be input to the gate terminal of the second input transistor M12 and a pixel signal PIX may be input to the gate terminal of the first input transistor M11. Source terminals of the first and second input transistors M11 and M12 may be connected to the first current source ISG through a common node N4. For example, the third and fourth output transistors M21 and M22 may be connected in the form of a current mirror. A sum of currents flowing through the first and second input transistors M11 and M12 may be equal to (or similar to) the first current source ISG. According to some example embodiments, the current mirror may be implemented by a current mirror circuit including the first and second input transistors M11 and M12 and the third and fourth output transistors M21 and M22. According to some example embodiments, the common node N4 may also be referred to herein as a second power voltage line.

A drain terminal of the first output transistor M21 and a drain terminal of the first input transistor M11 may be connected in common to first output nodes N1 and OUTP, and a gate terminal and a drain terminal of the second output transistor M22 and a drain terminal of the second input transistor M12 may be connected in common to second output nodes N2 and OUTN. A first output signal OUTP may be output from the first output node N1, and an inverted second output signal OUTN may be output from the second output node N2. For example, the first output signal OUTP may have a higher level (e.g., logic high) during a period at which the level of the ramp signal RAMP is higher than the level of the pixel signal PIX, and may have a lower level (e.g., logic low) during a period at which the level of the ramp signal RAMP is lower than the level of the pixel signal PIX.

In case of the comparator 151, the pixel signal Vpx is input to the first input transistor M11 of two input transistors, and the ramp signal RAMP is input to the second input transistor M12. In the second input transistor of the comparator 151, a magnitude of a parasitic capacitor Cgs between a gate and a source and a magnitude of a parasitic capacitor Cds between a drain and a source are changed depending on an operation region.

The ramp signal generator 130 considers an input terminal (Parasitic Capacitor =Cgs and Cds) of the comparator 151 of several tens to thousands of single-slope analog-to-digital conversion devices respectively connected to the ramp voltage buffer 140-k as load, and is driven step by step during operation.

When a gate voltage of the second input transistor M12 to which a buffered ramp signal RAMP is input gradually descends during operation, and when the descending gate voltage becomes the same as (or similar to) a gate voltage of the first input transistor M11 to which the pixel signal Vpx is input, the comparator 151 outputs a comparison signal, the counter performs counting, and the memory stores the counting value.

However, even though the comparator 151 outputs the comparison signal from the output nodes N1 and N2 (OUTP and OUTN), the gate voltage of the second input transistor M12 to which the ramp signal RAMP is input continues to descend because the ramp signal RAMP is input until it reaches a preset (or alternatively, given) range while descending.

Accordingly, the voltage of the output node of the first input transistor M11 continues to descend, so that the operation region of the first input transistor M11 is changed from a saturation region to a triode region or a linear region (e.g., the first input transistor M11 looks like a resistor due to a decrease in a voltage Vds between the drain and the source of the first input transistor M11).

Kickback noise may occur as a portion (e.g., the comparator 151-2) of a plurality of comparators 151-1 to 151-4 outputs a comparison result at an operation period. In detail, kickback noise may be introduced into a voltage CRB of the ramp voltage buffer 140-k through a gate-drain capacitor Cgd of the comparator 151-2 by voltage movement of the second input transistor M12 of the comparator 151-2. Kickback noise may also affect the comparators 151-1 and 151-3 of adjacent column lines.

That is, there is a disadvantage in that banding noise occurs due to kickback noise in which the load of the ramp signal generator 130 is changed depending on an operation status of the comparator 151, and operation performance of cross-correlation double sampling (CDS) is affected by existing operation points that are all changed. Banding noise may be defined as occurrence of a non-linear phenomenon as the operation of other peripheral circuits is affected by an operation status of each circuit. For example, when a difference between a pixel signal level of a first pixel belonging to the first column line and a pixel signal level of a second pixel belonging to the second column line adjacent to the first column line is larger, the parasitic capacitances Cgd and CRS may be increased to affect the operation of the peripheral comparators 151-1, 151-3 and 151-4, thereby shaking the ramp signal RAMP to cause the non-linear phenomenon.

In order to mitigate occurrence of the banding noise, the voltage buffer 140 is additionally provided for isolation to reduce a banding phenomenon between the output terminal of the ramp signal generator 130 and the input transistor M12 of each comparator, and the ramp signal is input to each comparator through the voltage buffer 140.

The ramp voltage buffer 140-k may include a second current source ISB and an NMOS transistor MB. The second current source ISB supplies a constant current through the NMOS transistor MB, and the NMOS transistor MB serves as a current sink, and a gate-source voltage Vgs is changed depending on the ramp signal RAMP applied to a gate so that a drain current is adjusted. That is, the NMOS transistor MB outputs the buffered ramp signal RBUF which is adjusted based on the ramp signal RAMP. That is, the ramp signal may be stably provided to the comparator due to the second current source ISB. However, the voltage movement of the adjacent second input transistor M12 may be introduced as the kickback noise based on the parasitic capacitors Cgd, Cgs and CRS, and the buffered ramp signal (RBUF_PR signal graph) may be shaken by the kickback noise.

The internal clamping control transistor M3 has a diode-connected structure so that the voltage level of the common node N3 of the first output transistor M21 and the second output transistor M22 is not decreased below a predetermined (or alternatively, given) threshold voltage, thereby restricting a swing width of the output signal OUTN of the second output transistor M22 and the output signal OUTP of the first output transistor M21.

That is, even though an input pixel signal Vpx1 has a larger voltage difference from a pixel signal Vpx2 of the adjacent column line, the comparator 151 controls the voltage level of the node N3 so as not to be decreased above a certain level due to the internal clamping control transistor M3, thereby restricting a swing width of the output node N2 of the second output transistor M22, and thus reducing the inflow of kickback noise by the gate-drain capacitor Cgd into the ramp signal RBUF.

In the example shown in FIGS. 4, 5 and 6, when a slope of the voltage level is shaken at the period (e.g., \textcircled{5}\textcircled{6} of FIG. 3) at which the ramp signal RBUF_PR is decreased due to the kickback noise when the internal clamping control transistor M3 is not present, the output signal output to the output nodes OUTN and OUTP of the comparator 151 may have a larger swing width like OUTN_PR and OUTP_PR. However, even though the voltage slope of the ramp signal RBUF_PR is shaken by the adjacent column line, the internal clamping control transistor M3 may reduce the influence on the node N3, thereby reducing the swing width of the output signal OUTN (see, e.g., FIG. 6). Like output signals OUTN_NMOS and OUTP_NMOS, the swing width may be reduced as compared with OUTN_PR and OUTP_PR. Therefore, the kickback noise that affects the output terminal of the voltage buffer 140 by the output signal OUTN is more reduced like ramp signal voltage shaking RBUF′ when the internal clamping control transistor M3 is present than ramp signal voltage shaking RBUF_PR when the internal clamping control transistor is not present. As a result, the voltage level difference before and after the decision operation of the comparator 151, that is, the swing width may be reduced. Therefore, resolution of the image sensor may be improved.

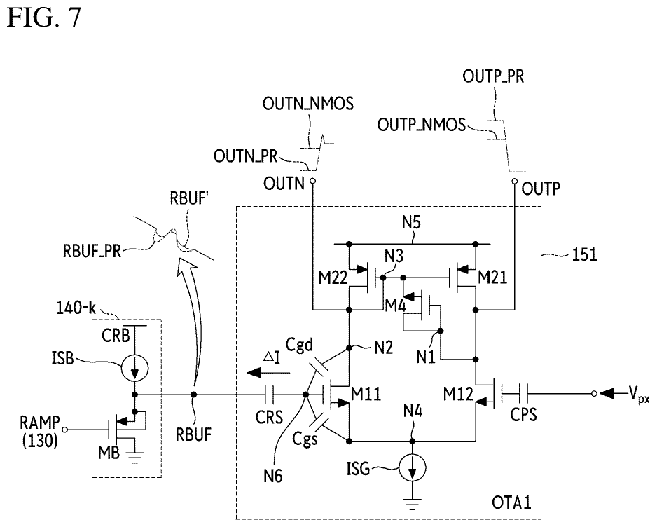

FIG. 7 is a circuit diagram illustrating some example embodiments of the comparator 151 in the ADC block 150 of FIG. 2. For convenience of description, the following description will be based on differences from FIG. 4.

The comparator 151 of FIG. 7 may include a plurality of transistors M11, M12, M21, M22 and M4, a plurality of switches, and a first current source ISG. For example, the first input transistor M11, the second input transistor M12 and the internal clamping control transistor M4 may be NMOS transistors, and the first output transistor M21 and the second output transistor M22 may be PMOS transistors. The fourth output transistor M22 may be implemented as a PMOS transistor having a diode-connected structure in which a gate and a drain are connected to the common node N3.

The internal clamping control transistor M4 may be implemented as an NMOS transistor having a diode-connected structure in which a drain and a gate are connected to one node. The drain of the internal clamping control transistor M4 is connected to a drain node N1 of the first output transistor M21, and a source of the internal clamping control transistor M4 is connected to a gate (N3) node of the third output transistor M21, which is a common node of a current mirror. The gate of the internal clamping control transistor M4 is connected to the drain node N1 of the first output transistor M21.

The internal clamping control transistor M4 has a diode-connected structure so that the voltage level of the common node N3 of the first output transistor M21 and the second output transistor M22 is not decreased below a predetermined (or alternatively, given) threshold voltage. As a result, the swing width of the output signal OUTN_NMOS of the second output transistor M22 and the output signal OUTP_NMOS of the first output transistor M21 may be restricted.

That is, even though the input pixel signal Vpx1 has a larger voltage difference from the pixel signal Vpx2 of the adjacent column line, the comparator 151 controls the voltage level of the node N3 so as not to be decreased above a certain level due to the internal clamping control transistor M4, thereby restricting the swing width of the output node N2 of the second output transistor M22. As a result, the inflow of kickback noise into the voltage buffer 140 by the gate-drain capacitor Cgd may be reduced.

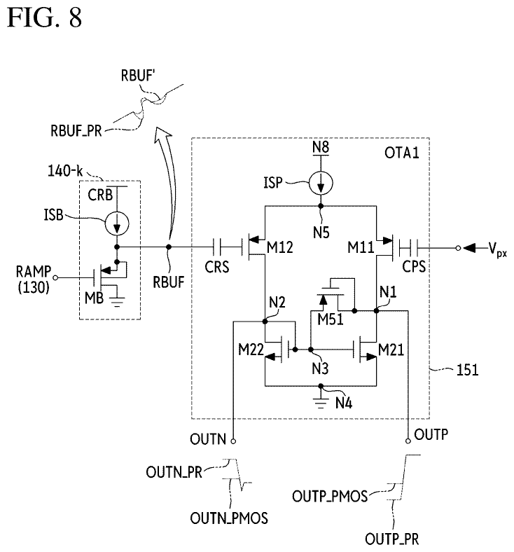

FIG. 8 is a circuit diagram illustrating some example embodiments of the comparator 151 in the ADC block 150 of FIG. 2. For convenience of description, the following description will be based on differences from FIG. 4.

Referring to FIG. 8, the comparator 151 may include a plurality of transistors M11, M12, M21, M22 and M51, a plurality of switches (not shown), and a third current source ISP. For example, the first input transistor M11, the second input transistor M12 and the internal clamping control transistor M51 may be PMOS transistors, and the first output transistor M21 and the second output transistor M22 may be NMOS transistors.

Sources of the first and second input transistors M11 and M12 are connected to the third current source ISP, the pixel signal Vpx is input to the gate of the first input transistor M11, and the ramp signal RBUF is input to the gate of the second input transistor M12. That is, unlike the example of FIG. 4, the pixel signal Vpx and the ramp signal RBUF, which are input signals, are input through the PMOS transistor in the comparator 151 of FIG. 8. Therefore, the input ramp signal RBUF has a slope opposite to that of FIGS. 4 to 7.

The second output transistor M22 may be implemented as an NMOS transistor having a diode-connected structure in which a gate N3 and a drain N2 are connected to each other. The internal clamping control transistor M51 may be implemented as a PMOS transistor having a diode-connected structure in which a drain and a gate are connected to a common node N1. A source of the internal clamping control transistor M51 is connected to a gate common node N3 of the first output transistor M21 and the second output transistor M22, which is a common node of the current mirror. A gate and a drain of the internal clamping control transistor M51 are connected to the output node N1 of the first output transistor M21. According to some example embodiments, sources of the first output transistor M21 and the second output transistor M22 may be connected to the common node 4 (e.g., a power voltage line) that may be grounded.

Since the internal clamping control transistor M51 has a diode-connected structure, it serves as a diode turned off at a predetermined (or alternatively, given) threshold voltage based on the voltage level of the common node N3 of the first input transistor M11 and the second input transistor M12. Accordingly, the swing width of the output signal OUTN_PMOS of the second output transistor M22 and the output signal OUTP_PMOS of the first output transistor M21 may be restricted.

That is, even though the input pixel signal Vpx1 has a larger voltage difference from the pixel signal Vpx2 of the adjacent column line, the comparator 151 controls the voltage level of the N3 node so as not to be decreased above a certain level due to the internal clamping control transistor M51, thereby restricting the swing width of the output node N2 of the second output transistor M22. As a result, the inflow of kickback noise into the voltage buffer 140 by the gate-drain capacitor Cgd may be reduced.

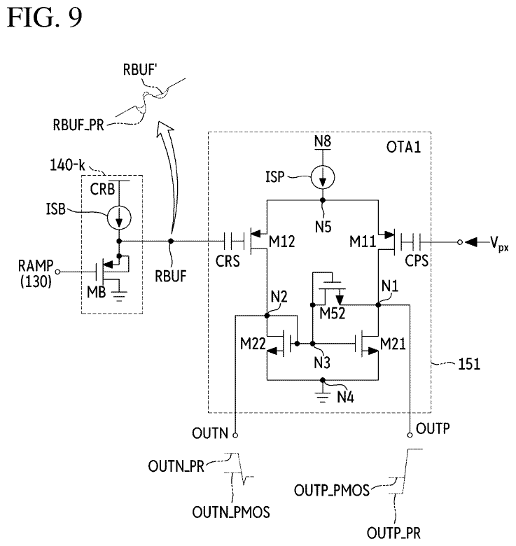

FIG. 9 is a circuit diagram illustrating some example embodiments of the comparator 151 in the ADC block 150 of FIG. 2.

Referring to FIG. 9, the comparator 151 may include a plurality of transistors M11, M12, M21, M22 and M52, a plurality of switches (not shown), and a third current source ISP. For example, the first input transistor M11 and the second input transistor M12 may be PMOS transistors, and the internal clamping control transistor M52, the first output transistor M21 and the second output transistor M22 may be NMOS transistors. The second output transistor M22 may be implemented as an NMOS transistor having a diode-connected structure in which a gate and a drain are connected to the common node N3.

The internal clamping control transistor M52 may be implemented as an NMOS transistor having a diode-connected structure in which a drain and a gate are connected to the common node N3. A source of the internal clamping control transistor M52 is connected to the output node N1 of the first output transistor M21, and the gate and the drain of the internal clamping control transistor M52 are connected to a gate terminal common node N3 of the first output transistor M21 and the second output transistor M22.

Sources of the first and second input transistors M11 and M12 are connected to the third current source ISP, the pixel signal Vpx is input to the gate of the first input transistor M11, and the ramp signal RBUF is input to the gate of the second input transistor M12.

The second output transistor M22 may be implemented as a PMOS transistor having a diode-connected structure in which a gate N3 and a drain N2 are connected to each other. The source of the internal clamping control transistor M52 is connected to the output node N1 of the first output transistor M21, and the gate and the drain of the internal clamping control transistor M52 are connected to the common gate node N3 of the output transistors M21 and M22. The internal clamping control transistor M52 may be implemented as an NMOS transistor having a diode-connected structure in which the drain and the gate are connected to the common node N3.

Since the internal clamping control transistor M52 has a diode-connected structure, it serves as a diode turned off at a predetermined (or alternatively, given) threshold voltage based on the voltage level of the common gate node N3 of the output transistors. Accordingly, the swing width of the output signal OUTN_PMOS of the second output transistor M22 and the output signal OUTP_PMOS of the first output transistor M21 may be restricted.

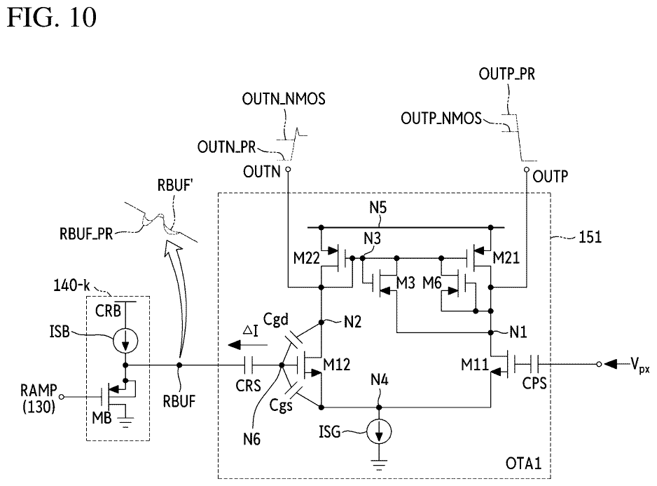

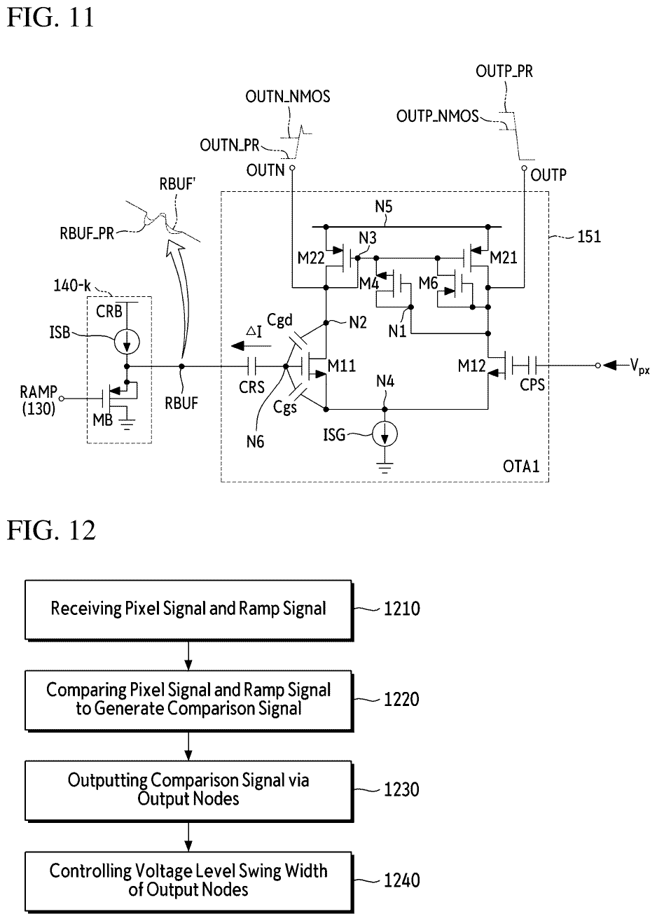

FIG. 10 is a circuit diagram illustrating some example embodiments of the comparator 151 in the ADC block 150 of FIG. 2, and FIG. 11 is a circuit diagram illustrating some example embodiments of the comparator 151 in the ADC block 150 of FIG. 2.

Referring to FIGS. 4 and 10 together, the comparator 151 of FIG. 10 further includes a second internal clamping control transistor M6 as compared with the comparator 151 of FIG. 3. The second internal clamping control transistor M6 of FIG. 10 is a PMOS transistor, and a source and a gate of the second internal clamping control transistor M6 are connected to the drain of the first output transistor M21, e.g., the output node N1, and a drain of the second internal clamping control transistor M6 is connected to the common node of the current mirror, e.g., the common gate node N3 of the first output transistor M21 and the second output transistor M22.

Referring to FIGS. 7 and 11, the comparator 151 of FIG. 11 further includes a second internal clamping control transistor M6 as compared with the comparator 151 of FIG. 7. The second internal clamping control transistor M6 of FIG. 11 is a PMOS transistor, a source and a gate of the second internal clamping control transistor M6 are connected to the drain of the first output transistor M21, e.g., the output node N1, and a drain of the second internal clamping control transistor M6 is connected to the common node of the current mirror, e.g., the common gate node N3 of the first output transistor M21 and the second output transistor M22.

Referring to FIGS. 10 and 11, the comparator 151 outputs two output signals OUTN and OUTP as a comparison result. The first internal clamping control transistor (M3 of FIG. 10 and M4 of FIG. 11) may stabilize the operation of the second output transistor M22, and the second internal clamping control transistor (M6 of FIGS. 10 and 11) may stabilize the operation of the first output transistor M21 in a direction of a pixel signal input terminal. The first internal clamping control transistors M3 and M4 and the second internal clamping control transistor M6 may be connected in a diode loop structure in which an input and an output are engaged with each other. That is, the input of the first internal clamping control transistor M3 (or M4) is connected to the output of the second internal clamping control transistor M6, and the output of the first internal clamping control transistor (M3 or M4) is connected to the input of the second internal clamping control transistor M6, so that an upper limit level and a lower limit level of a swing width may be adjusted together based on a threshold voltage level of the internal clamping control transistors M3 and M6. Therefore, clamping of the output signals OUTP and OUTN, that is, the swing width may be more efficiently restricted.

FIG. 12 is a flowchart illustrating a method for controlling a voltage level swing width according to some example embodiments.

Referring to FIG. 12, a method is provided for controlling a voltage level swing width of output nodes of a comparator. According to some example embodiments, the method may be performed by the comparator 151 of any of the examples discussed above.

Operation 1210 includes receiving a pixel signal and a ramp signal. For example, the pixel signal may be received from the pixel array 110 (e.g., via one of the column lines). The ramp signal may be a buffered ramp signal received from one of the voltage buffers 140.

Operation 1220 includes comparing the pixel signal and the ramp signal to generate a comparison signal. For example, operation 1220 may include performing correlated double sampling (CDS) as discussed above.

Operation 1230 includes outputting the comparison signal via output nodes. For example, the output signals OUTN and OUTP may be output via the output nodes.

Operation 1240 includes controlling a voltage level swing width of the output nodes. For example, operation 1240 may involve controlling a voltage level of a common gate node between output transistors using an internal clamping control transistor having a diode-connected structure such that a voltage level of a common node between output transistors does not decrease below a threshold voltage.

Conventional devices and methods for converting an analog electrical signal in an image sensor to a digital signal experience excessive noise due to interference from adjacent analog to digital conversions. For example, the conventional devices include a plurality of analog to digital converters (ADCs), each of which is configured to receive an analog electrical signal from a corresponding column line and convert the analog electrical signal to a digital signal. An ADC may experience kickback noise based on operation of one or more other ADCs on adjacent column line(s). The operation of the one or more other ADCs results in variations in a voltage of an input ramp signal that results in kickback noise at the ADC. The kickback noise results in a larger swing width in the output of the ADC, reducing a resolution of the image sensor.

However, according to some example embodiments, improved devices and methods are provided for converting an analog electrical signal in an image sensor to a digital signal. For example, the improved devices and methods involve ADCs that utilize an internal clamping control transistor that has a diode-connected structure such that a voltage level of a common node between output transistors does not decrease below a threshold voltage. Accordingly, a swing width of an output signal of the ADCs is controlled (e.g., restricted). By so reducing the swing width of the output signal, the resolution of the image sensor is improved. Therefore, the improved devices and methods overcome the deficiencies of the conventional devices and methods to at least improve image sensor resolution.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

When one constituent element is described as being “coupled” or “connected” to another constituent element, it should be understood that one constituent element may be coupled or connected directly to another constituent element, and an intervening constituent element may also be present between the constituent elements. When one constituent element is described as being “coupled directly to” or “connected directly to” another constituent element, it should be understood that no intervening constituent element exists between the constituent elements.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

What is claimed is:

1. An image sensor comprising:
a plurality of ramp voltage buffers configured to buffer a ramp signal;
a pixel array including,
a plurality of pixels, and
a plurality of column lines respectively connected to the plurality of pixels; and
a plurality of comparators, each of the plurality of comparators being configured to,
receive the buffered ramp signal from one of the ramp voltage buffers,
receive a pixel signal via one of the plurality of column lines,
compare the buffered ramp signal with the pixel signal, and
output a comparison signal via output nodes, a voltage level swing width of the output nodes being restricted based on control of a voltage level of a common gate node between output transistors.

2. The image sensor of claim 1, wherein
the output transistors include a first output transistor and a second output transistor; and
each of the plurality of comparators includes:
the first output transistor including,
a source connected to a first power voltage line,
a drain connected to a first output node, and
a gate connected to a second output node,
the second output transistor including,
a source connected to the first power voltage line, and
a gate and a drain connected to the second output node; and
a first internal clamping control transistor including,
a source connected to the first output node, and
a gate and a drain connected to the second output node, the first internal clamping control transistor being configured to control a voltage level of the first output node and a voltage level of the second output node.

3. The image sensor of claim 2, wherein each of the plurality of comparators further includes:
a first input transistor including,
a gate configured to receive the pixel signal,
a source connected to a second power voltage line, and
a drain connected to the first output node; and
a second input transistor including,
a gate configured to receive the ramp signal,
a source connected to the second power voltage line, and
a drain connected to the second output node.

4. The image sensor of claim 3, wherein the first output transistor, the second output transistor, the first input transistor and the second input transistor operate as a current mirror circuit.

5. The image sensor of claim 2, wherein each of the plurality of comparators further includes:
a second internal clamping control transistor including,
a source connected to the first output node, and
a gate and a drain both connected to the second output node, the second internal clamping control transistor controlling the voltage level of the first output node and the voltage level of the second output node.

6. The image sensor of claim 1, further comprising:
a plurality of counters, each of the plurality of counters counting the comparison signal of a corresponding comparator among the plurality of comparators according to an operating clock to obtain a counting result; and
a plurality of memories storing the counting result at a period at which the ramp signal descends.

7. A comparison device comprising:
a current mirror circuit configured to,
receive a ramp signal and a pixel signal, and
compare the ramp signal with the pixel signal to output a first comparison signal and a second comparison signal, the first comparison signal being output through a first output node of a first output transistor, and the second comparison signal being output through a second output node of a second output transistor; and
a first internal clamping control transistor connected in a diode-connected structure between a common gate node and the first output node, the common gate node being between the first output transistor and the second output transistor, and the first internal clamping control transistor being configured to restrict a voltage swing width of the second comparison signal.

8. The comparison device of claim 7, wherein the first internal clamping control transistor is a PMOS transistor including:
a source connected to the first output node; and
a gate and a drain connected to the common gate node.

9. The comparison device of claim 7, wherein the first internal clamping control transistor is an NMOS transistor including:
a source connected to the common gate node; and
a gate and a drain connected to the first output node.

10. The comparison device of claim 8, further comprising:
a second internal clamping control transistor, the second internal clamping control transistor being a PMOS transistor including,
a source and a gate connected to the first output node, and
a drain connected to the common gate node.

11. The comparison device of claim 7, wherein the current mirror circuit includes:
a first input transistor including,
a gate configured to receive the pixel signal,
a source connected to a first power voltage line, and
a drain connected to the first output node; and
a second input transistor including:
a gate configured to receive the ramp signal,
a source connected to the first power voltage line, and
a drain connected to the second output node.

12. The comparison device of claim 11, wherein
the first output transistor includes,
a source connected to a second power voltage line,
a drain connected to the first output node, and
a gate connected to the second output node, and
the second output transistor includes,
a source connected to the second power voltage line, and
a gate and a drain connected to the second output node.

13. An image sensor comprising:
a ramp signal generator configured to generate a ramp signal;
a plurality of ramp voltage buffers configured to buffer the ramp signal;
a pixel array configured to output a pixel signal through a plurality of column lines, the pixel signal corresponding to incident light;
a plurality of comparators, each of the plurality of comparators including,
a first output transistor having,
a gate connected to one of the plurality of column lines, and
a drain connected to a first output node,
a second output transistor having,
a gate connected to one of the plurality of ramp voltage buffers, and
a drain connected to a second output node, and
a first internal clamping control transistor connected in a diode-connected structure between the first output node and a common gate node of the first output transistor and the second output transistor, the first internal clamping control transistor being configured to control a voltage level of the second output node by controlling a gate voltage of the first output transistor and the second output transistor, and
each of the plurality of comparators being configured to output a comparison signal to the first output node and the second output node, the comparison signal corresponding to a comparison between the pixel signal and the buffered ramp signal;
a plurality of counters configured to count the comparison signal output from each of the plurality of comparators according to an operating clock to obtain counting information; and
a plurality of memories configured to store the counting information from the plurality of counters, image data being output based on the counting information stored in the memory.

14. The image sensor of claim 13, wherein each of the plurality of comparators includes:
a first input transistor including,
a gate configured to receive the pixel signal,
a source connected to a first power voltage line, and
a drain connected to the first output node; and
a second input transistor including,
a gate configured to receive the ramp signal,
a source connected to the first power voltage line, and
a drain connected to the second output node.

15. The image sensor of claim 14, wherein
the first output transistor includes,
a source connected to a second power voltage line,
a drain connected to the first output node, and
a gate connected to the second output node, and
the second output transistor includes,
a source connected to the second power voltage line, and
a gate and a drain both connected to the second output node.

16. The image sensor of claim 13, wherein the first internal clamping control transistor is a PMOS transistor including:
a source connected to the first output node; and
a gate and a drain connected to the common gate node.

17. The image sensor of claim 13, wherein the first internal clamping control transistor is an NMOS transistor including:
a source connected to the common gate node; and
a gate and a drain connected to the first output node.

18. The image sensor of claim 13, wherein the first internal clamping control transistor is configured to turn off according to a source voltage level of the first internal clamping control transistor to restrict an upper limit of a voltage level of an output signal at the second output node.

19. The image sensor of claim 16, further comprising:
a second internal clamping control transistor, the second internal clamping control transistor being a PMOS transistor including,
a source and a gate connected to the first output node, and
a drain connected to the common gate node.

20. The image sensor of claim 19, wherein the second internal clamping control transistor is configured to turn off according to a source voltage level of the second internal clamping control transistor to restrict a lower limit of voltage levels of output signals at the first output node and the second output node.
